(19) United States
(12) Patent Application Publication
(10) Pub. No.: US 2006/0092317 A1
(43) Pub. Date: May 4, 2006

(54) Camera support arm

(76) Inventor: Robert N. Elnicky, Troy, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/531,972

(22) PCT Filed: Oct. 28, 2003
(86) PCT No.: PCT/US03/34190

§ 371 Date: Sep. 28, 2005

Related U.S. Application Data
(60) Provisional application No. 60/421,831, filed on Oct. 28, 2002.

(51) Int. Cl. H04N 5/225; H04N 7/18

(52) U.S. Cl. 348/373; 348/157

(57) ABSTRACT

An assembly for mounting a remotely controlled camera (14) includes a frame affixed to a mounting surface for supporting the camera. A first member (32) is rotationally mounted to the frame (24) defining a first axis of rotation. A second member (34) is rotationally mounted to the first member (32) defining a second axis of rotation (36) intersecting the first axis of rotation. The camera (14) is rotationally mounted to the second member (34) at a location spaced from the second axis of rotation (36) so that the camera rotates around at least a third axis and a fourth axis relative to the second member.

### FIELD OF THE INVENTION

The present invention relates generally toward an assembly for mounting a remote controlled camera. More specifically, the invention relates toward an assembly for mounting a camera to provide unique angles of photography at sporting or other entertainment events.

### BACKGROUND OF THE INVENTION

To benefit television viewership of athletic events, efforts have been made to improve the visual angles a camera can videotape the athletic event for transmission. One widely used method of filming a sporting event uses a camera suspended from a wire stretching across an athletic field or arena. The camera is remotely controlled and moves along the cable to track the action of the sporting event. This camera arrangement generally allows rotation of the camera around two axis, but merely provides a long distance view of the sporting event.

Occasionally, a camera has been mounted to the helmet of an athlete to provide a field level view of the athletic event to enhance the excitement for the television audience. While a camera mounted in this manner has provided some unique camera angles, rarely does the camera actually produce a desirable line of sight for taping or transmission. Recent improvements in computer technology has provided a 360° view of the athletic event, but has required the use of a significant number of cameras spaced around the athletic field or arena. The computer correlates each of the images from these cameras to produce a three dimensional view of the athletic event. However, this three dimensional view can only be replayed at a later time and is not intended for use in real time transmission. Furthermore, the installation of this system has proven to be quite expensive and has only been used on a limited basis.

Because of the drawbacks of the camera assemblies discussed above, the most frequent form of filming an athletic event still relies upon a few stationary cameras manned by cameramen, each of which track the athletic event from a different angle. It is still a goal of both television networks and athletic associations to improve the methods used to film athletic events to enhance a television viewer's experience. Therefore, it would be desirable to provide an improved camera assembly capable of providing images of an athletic event to enhance the experience of the television viewer.

### SUMMARY OF THE INVENTION

An assembly for mounting a remote controlled camera uses a frame affixed to a mounting surface for supporting the camera. A first member is rotationally mounted to the frame and defines a first axis of rotation. A second member is rotationally mounted to the first member and defines a second axis of rotation that intersects with the first axis of rotation. The camera is rotationally mounted to the second member at a location spaced from the second axis and rotates around at least a third and fourth axis relative to the second member.

By mounting a camera upon an assembly having the configuration set forth above, which provides four axis of rotation, unique camera angles and lines of sight can be established to produce exciting images of an event for television viewership. By adjusting the length of the second member, a camera can be suspended just a few feet from an athletic event to produce images that replicate participating in the occurring event. Furthermore, providing four axis of rotation enables a real time image to be generated from 360° around the event with a single camera. None of the prior art assemblies used to mount a remotely controlled camera have been able to provide this imagery.

Mounting a camera in this manner, is particularly suited for filming fast moving athletic events such as, for example, hockey, boxing and basketball, each of which has proven to be difficult to film except from a stationary camera having a wide angle lens adjustment. Moving a camera along four axis, can give the appearance of actually moving along with the players of an athletic event up and down the athletic field or arena heretofore not previously available.

### BRIEF DESCRIPTION OF THE DRAWINGS

Other advantages of the present invention will be readily appreciated as the same becomes better understood references to the following detailed description when considered in connection with the accompanying drawings wherein:

FIG. 1 is a top down view of the inventive camera assembly positioned over a hockey rink;

FIG. 2 is a side view of the inventive camera assembly showing various lines of sight of a player in an athletic event;

FIG. 3 is a bottom view of the inventive camera assembly showing various angles of rotation;

FIG. 4 is a side view of the camera assembly showing movement of the camera in a generally vertical direction;

FIG. 5 shows an alternative arrangement of the camera assembly; and

FIG. 6 shows two axis of rotation of the camera rotationally mounted on the camera assembly.

### DETAILED DESCRIPTION OF THE INVENTION

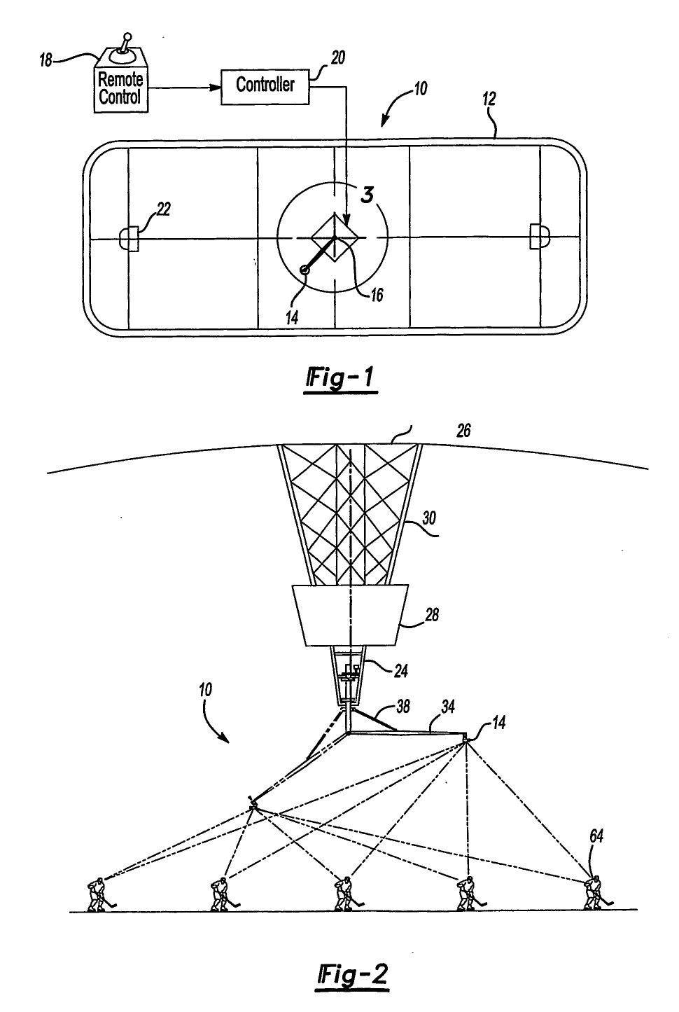

Referring to FIG. 1, an assembly for mounting a remote controlled camera is generally shown at 10 centrally located over a hockey rink 12. The assembly 10 supports a camera 14 in a manner that allows the camera to be rotated above the rink 12 along a first axis of rotation 16 360° providing unique angles of photography for the event taking place below. While a hockey rink is represented in FIG. 1, other venues for use are also contemplated by the inventor including, but not limited to, boxing, basketball, various outdoor sporting events, and indoor and outdoor performance arts, such as, for example, concerts. The assembly 10 is preferably operated via a remote control 18 with the assistance of a controller 20. The remote control can take the form of a joy stick (not shown) or other device capable of translating movement from an operator to the assembly 10. The controller 20 is programmed with software enabling a translation of the movement generated by the operator via the remote control 18 to pivot, pan, tilt, and zoom the focus of the camera to adjust the photographic angles of the event taking place below.

Furthermore, the software is contemplated to use a kinomatic model to enhance the operation of the assembly 10 by the operator. For example, the software, via the controller 20, will dampen the movement of the assembly 10 to reduce or eliminate vibration or uneven movements of the assembly 10 by the operator. The software, via the controller 20, will even slow down the movement of the assembly 10 to assist the operator in transitioning from one photographic angle to another. To assist this function, each of the electromechanical elements used to manipulate the assembly 10, which are set forth below, transmit computer readable signals to the controller indicating the location and direction of the camera. This enables the operator to move the camera in real time to track the event occurring below. The remote control 18 is alternatively mounted above a screen showing the arena 12 and the location of the assembly 10 relative to the arena 12 to better enable the operator to follow the event taking place below the assembly 10. A still further alternative allows the operator to view the event through a virtual reality head set and to move the assembly accordingly.

A still further Alternative, contemplates the controller 20 being programmed with predetermined locations so that the assembly 10 may be immediately moved upon the push of a button, such as, for example, to the front of a net 22 of a hockey arena 12. This allows the operator to rapidly film action occurring at the predetermined location.

The software programmed to the controller 20 also detects vibration occurring as a result of rapid movements of the assembly 10 and adjusts the image generated by the camera 14 to eliminate transmission of a vibration which may distort the image. In each of the cases set forth above, two way communication is generated between the controller 20 and the assembly 10, and the controller 20 and the remote control 18. The two way communication is contemplated to be generated via hardwire. However, RF communication, or some combination of hardwire and RF communication, may also be used to transmit the appropriate signals.

Referring now to FIG. 2, a preferred embodiment of the assembly 10 is shown having a frame 24 affixed to a mounting surface 26. Preferably, the mounting surface is a roof of an arena having a generally horizontal orientation. However, an appendage of the arena having a vertical orientation, or a truss otherwise mounted to the arena may also be used to derive the mounting surface 26.

One desirable location of the assembly 10 is at a spaced location beneath a scoreboard 28 that is generally suspended from the mounting surface 26 by a scoreboard truss 30. It is possible to construct the frame as a truss so that the frame 30 is inserted through the center of the scoreboard 28, which generally has an open center area. Preferably, the assembly 10 is located at a spaced location below the scoreboard 28 so that that assembly 10 may be located generally in the central area of the rink 12.

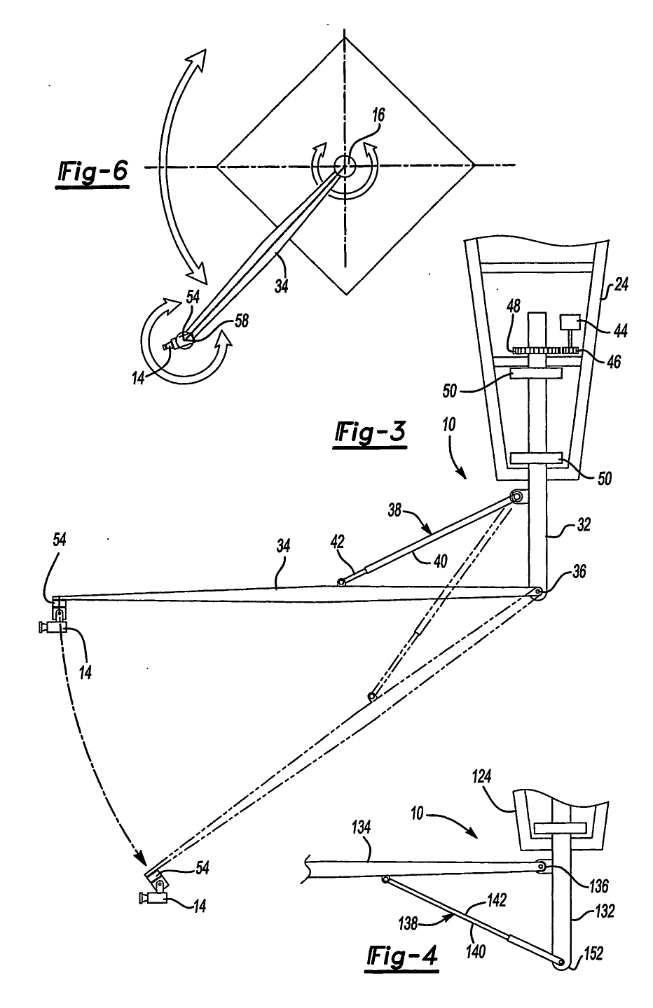

Referring now to FIG. 3, a first member 32 is rotationally mounted to the frame 24 defining a first axis of rotation 16 (FIGS. 1 and 5). A second member 34 is rotationally mounted to the first member 32 defining a second axis of rotation 36 that intersects the first axis of rotation 16. An actuator 38 is operably connected between the first member 32 and the second member 34 at spaced locations from the second axis of rotation 36.

The actuator 32 rotates the second member 34 around the second axis of rotation 36 by lifting and lowering the second member 34. In this embodiment, the second axis of rotation 36 is generally located at a distal end 152 of the first member 32, at spaced location from the frame 124. The actuator 38 is driven by either servo-motors, hydraulically, or pneumatically. The actuator 38 is formed from a first element 40 and a second element 42 that telescopes relative to the first element 40 to rotate the second member 34 in a downward direction, and retract relative to the first element 40 to lift the second member 34 in an upward direction.

A drive motor 44 is operably connected to the first member 32 via a first gear 46 that drivably engages a second gear 48 disposed upon the first member 32. The gears 46, 48 translate rotational movement to the first member 32 thereby pivoting the first member 32 around the first axis as will be explained further below.

Referring now to FIG. 4, an alternative embodiment of the assembly is generally shown at 110. In this embodiment, a first member 132 includes a distal end 152 that is spaced from the frame 124 and the second axis of rotation 136 is spaced above the distal end 152 of the first member 132. An actuator 138 is operably connected between the distal end 152 of the first member 132 and the second member 134 at a location spaced from the second axis of rotation 136. The actuator 138 operates in the same manner as the original embodiment to raise and lower the second member 134. However, to lower the second member 134, the second element 142 retracts into the first element 140 and to rotate the second member 134 in an upward direction, the second element 142 telescopes outwardly from the first element 140.

As best shown in FIG. 5, a mount 54 operably connects the camera 14 to the second member 34. The mount 54 includes a first motor 56 that rotates the camera 14 around a third axis of rotation 58. The third axis of rotation 58 allows the camera 14 to pan the arena 12 independent of the first axis of rotation 16. A second motor 60 rotates the camera 14 around a fourth axis of rotation 62. The fourth axis of rotation 62 allows the camera 14 to tilt independent of the second axis of rotation 36. The preferred mount 54 is a servo-CP pan/tilt head manufactured by Telemetrics, Inc., which provides a compact, lightweight mount to support the camera 14 by providing two axis 58, 60 of rotation to the camera 14. It should be understood by those of skill in the art that alternative mounts that provide two axis of rotation may also be used.

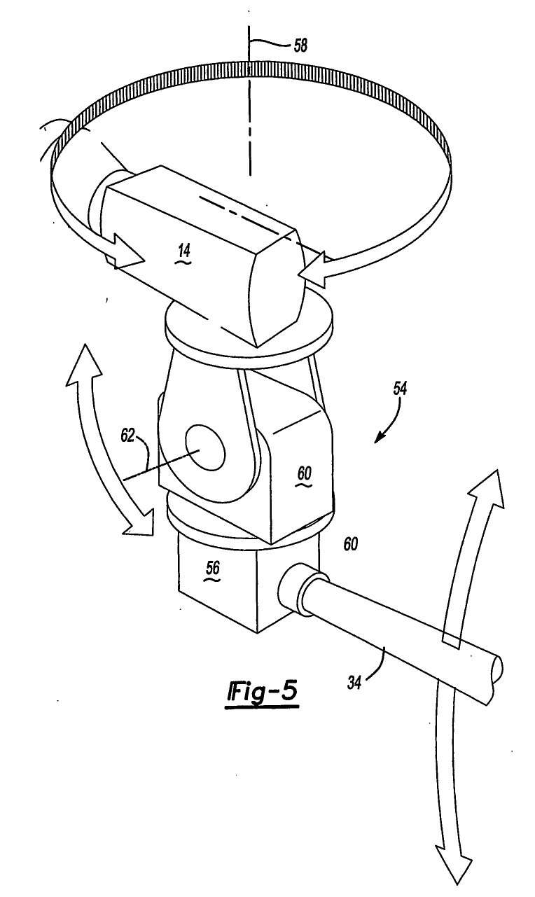

Referring now to FIG. 6, a schematic is shown of the assembly 10 wherein the 360° range of motion provided to the second member 34 is represented. The second member 34 pivots around the first axis 16, as set forth above, moving the camera 14 360° providing an unobstructed view for the camera 14 to every corner of the rink 12. The camera 14 additionally pivots around third axis 58 allowing the camera to focus on a single competitor taking a part in the event and follow the competitor around the arena 12 as though the camera 14 is moving along with the competitor 64. The speed of the event dictates the reaction time required of an operator. During a hockey game. The operator will have to manipulate the assembly 10 at a rapid pace. A basket ball game requires less rapid manipulation and a football game requires even less rapid manipulation than a basket ball game. The positioning of the assembly 10 prevents the camera 14 from ever interfering with the view of the audience of the event. This provides a seemingly limitless member of camera angles to photograph the competitor 60 as is best represented in FIG. 2. By pivoting the camera around the fourth axis 62 as shown in FIG. 5, unique angles can be obtained by rotating the second member 34 around the second axis of rotation 36 as best represented in phantom in FIG. 2. Therefore, the camera 14 can be lowered to nearly the same level as the event taking place below to give the viewer the illusion of being on the rink 12 while the event is taking place.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. An assembly for mounting a remotely controlled camera, comprising:
a frame affixed to a mounting surface for supporting the camera;
a first member rotationally mounted to said frame defining a first axis of rotation;
a second member rotationally mounted to said first member defining a second axis of rotation intersecting said first axis of rotation; and
said camera rotationally mounted to said second member at a location spaced from said second axis of rotation, wherein said camera rotates around at least a third axis and a fourth axis relative to said second member.

2. An assembly as set forth in claim 1, wherein said mounting surface comprises a generally horizontal plane.

3. An assembly as set forth in claim 1, wherein said frame comprises a truss suspended from said mounting surface.

4. An assembly as set forth in claim 1, comprising an actuator operably connected between said first member and said second member at locations spaced from said second axis of rotation.

5. An assembly as set forth in claim 4, wherein said actuator provides driving movement to said second member thereby rotating said second member around said second axis of rotation.

6. An assembly as set forth in claim 1, comprising a drive motor operably connected to said first member thereby rotating said first member around said first axis of rotation.

7. An assembly as set forth in claim 1, comprising a mount operably connecting said camera to said second member.

8. An assembly as set forth in claim 7, wherein said mount includes a first motor for rotating said camera around said third axis thereby panning said camera.

9. An assembly as set forth in claim 8, wherein said mount includes a second motor for rotating said camera around said fourth axis thereby tilting said camera.

10. An assembly as set forth in claim 1, wherein said first member comprises a distal end spaced from said frame and said second axis of rotation is positioned generally adjacent said distal end.

11. An assembly as set forth in claim 1, wherein said first member comprises a distal end spaced from said frame and said second axis of rotation is spaced from said distal end.

12. An assembly as set forth in claim 11, comprising an actuator operably connected between said distal end of said first member and said second member at a location spaced from said second axis of rotation.

13. A method of taping an event comprising the steps of:
providing a camera assembly suspended above the event wherein said assembly supports a camera movable around four axis defining 360° line of sight for said camera of the event;
providing a control device located at a remote location, wherein said control device is capable of moving said camera around said four axis;
moving said camera from said remote location by rotating said camera around said four axis; and
taping the event with said camera from said 360° line of sight by moving said camera around said four axis thereby generating an image of the event.

14. The method as set forth in claim 13, comprising the step of providing a controller device programmable for operating said camera assembly from said remote location.

15. The method as set forth in claim 13, comprising the step of following the event when the event moves below said camera assembly by moving said camera around said four axis from said remote location.

16. The method as set forth in claim 14, comprising moving said camera to a predetermined line of sight by programming said controller with said predetermined line of sight independent of said control device.

17. The method as set forth in claim 14, comprising step of programming said controller to adjust movements of said camera made from said control device thereby improving the quality of said image generated by said camera.

18. The method as set forth in claim 14, comprising programming said controller to adjust said image generated by said camera to reduce vibration generated from moving said camera assembly.

19. The method as set forth in claim 14, comprising the step of signally a location of said camera to said controller from said camera assembly.

20. The method as set forth in claim 13, comprising the step of filming the event from 360° with a single camera in real time.

21. The method as set forth in claim 13, wherein said step of rotating said camera around said four axis is further defined by rotating said camera around said four axis simultaneously.
